(19) United States
(12) Patent Application Publication
(10) Pub. No.: US 2014/0355259 A1
(43) Pub. Date: Dec. 4, 2014

(54) SOLAR STREET LIGHT

(71) Applicant: DJ SOLAR CO., LTD., Kuei Shan Hsiang (TW)

(72) Inventors: Lun-Yu KU, KUEI SHAN HSIANG (TW); Shih-Chieh LIAO, KUEI SHAN HSIANG (TW)

(21) Appl. No.: 13/906,338

(22) Filed: May 31, 2013

(51) Int. Cl. F21S 9/03

(52) U.S. Cl. CPC F21S 9/037
USPC 362/183

(57) ABSTRACT

A solar street light includes a lamp housing equipped with a bracket for mounting at a street light pole and photovoltaic panels for converting sunlight into electric energy, the lamp housing including a top panel, multiple peripheral panels, an accommodation chamber surrounded by the top panel and the peripheral panels, a fixed bottom panel and a movable bottom panel covering the accommodation chamber, a light source module mounted at an inner side of the movable bottom panel, and a battery set mounted in the accommodation chamber in between the top panel and the fixed bottom panel. When movable bottom panel is opened, a person can access to the light source module and the battery set, facilitating maintenance and repair work.

### BACKGROUND OF THE INVENTION

1. Field of the Invention

The present invention relates to street light technology and more particularly to a solar street light, which has the battery set mounted in the lamp housing and uses a flip-down type movable bottom panel to hold down the loaded battery set, facilitating battery set installation and replacement.

2. Description of the Related Art

A solar street light generally comprises a rechargeable battery set and photovoltaic panels for converting sunlight into electric energy to charge the rechargeable battery set. The battery set can be designed mountable on the inside or outside of the lamp housing. After a long use, the battery set may be getting old. When the battery set is getting old, it must be replaced with a new one so that the solar street light can work normally. If the battery set is mounted inside the lamp housing, the lamp housing must be opened so that the mechanic can access to the battery set. According to conventional designs, either equipped with flip-up or flip-down cover, it takes much labor and time to open the lamp housing and to replace the battery set.

### SUMMARY OF THE INVENTION

The present invention has been accomplished under the circumstances in view. It is the main object of the present invention to provide a solar street light, which uses a flip-down type movable bottom panel to carry a light source module and to hold down a battery set in the lamp housing, facilitating installation and maintenance of the battery set and the light source module.

It is another object of the present invention to provide a solar street light, which has a stop member provided at the inner side of the movable bottom panel so that when the movable bottom panel is closed, the stop member is stopped against the battery set in the lamp housing, holding down the battery set firmly in position.

### BRIEF DESCRIPTION OF THE DRAWINGS

FIG. 1 is an oblique bottom elevation of a solar street light in accordance with the present invention.

FIG. 2 is an oblique top elevation of the solar street light in accordance with the present invention.

FIG. 3 is an elevational view of a part of the present invention, illustrating the movable bottom panel opened.

FIG. 4 is an enlarged view of part A of FIG. 3.

FIG. 5 is a schematic exploded view illustrating the mounting arrangement between the battery set and the lamp housing.

FIG. 6 is a schematic drawing illustrating the pivoting structure between the movable bottom panel and one peripheral panels of the lamp housing.

### DETAILED DESCRIPTION OF THE PREFERRED EMBODIMENT

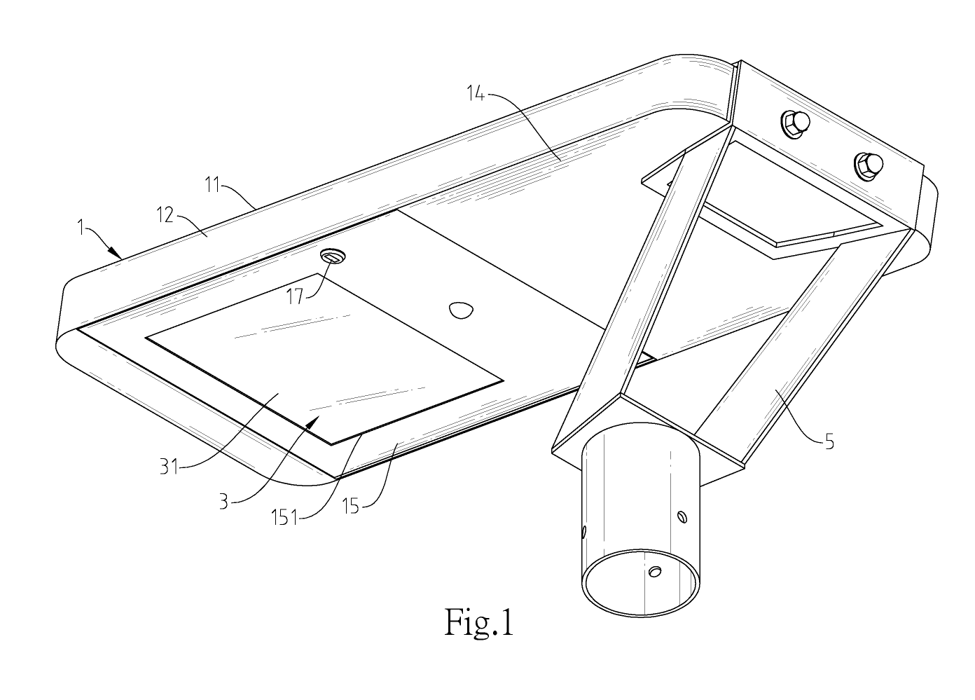

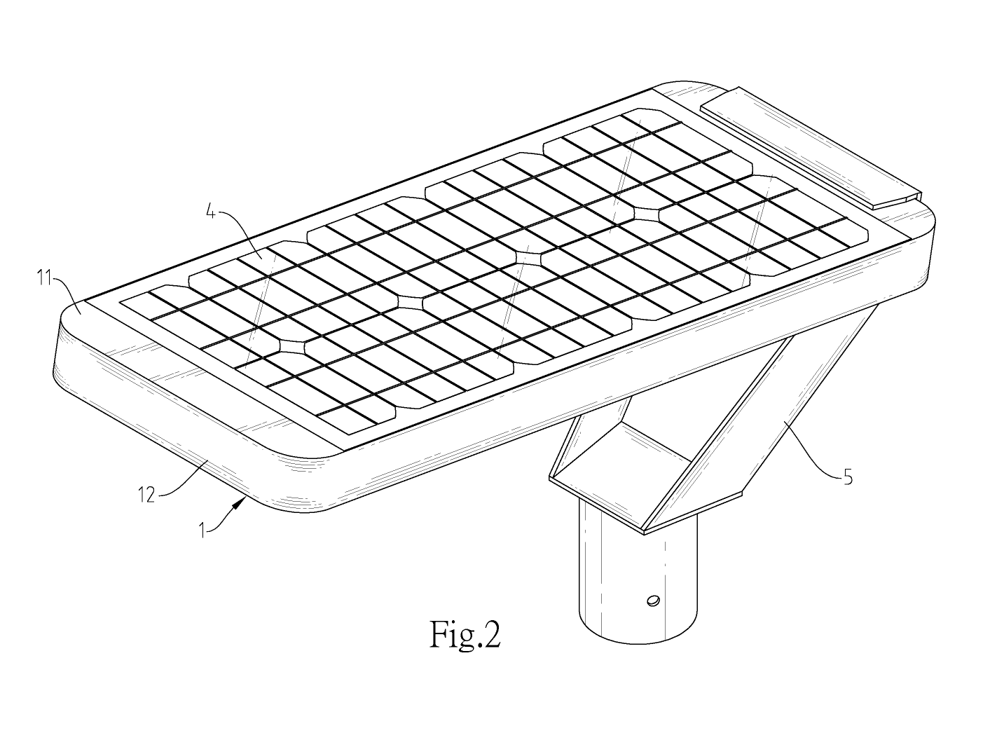

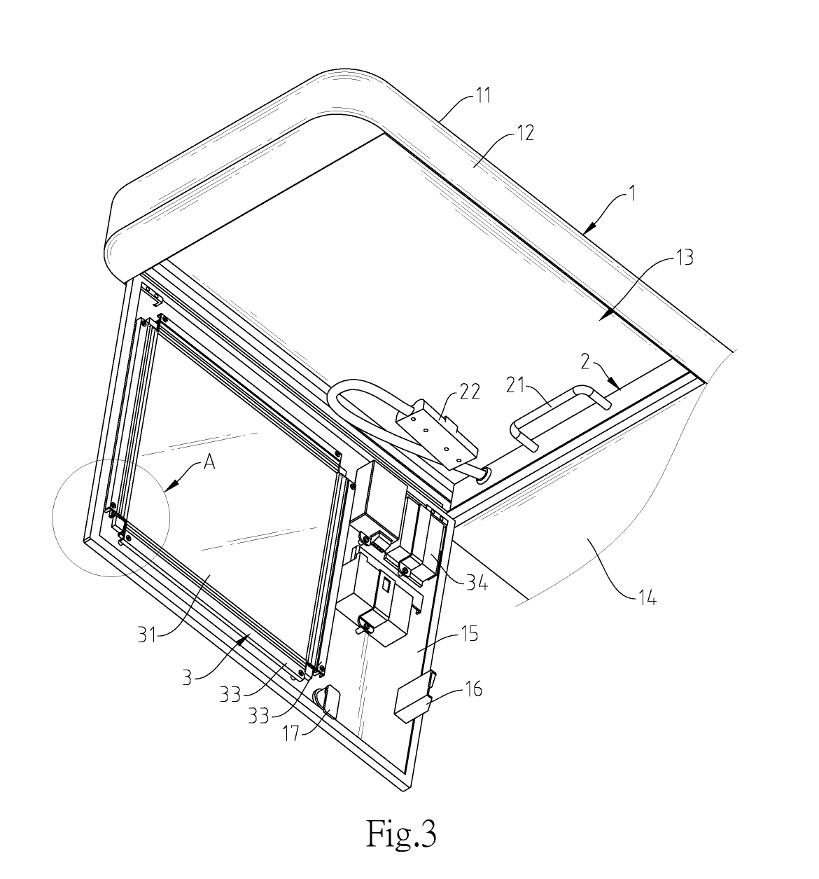

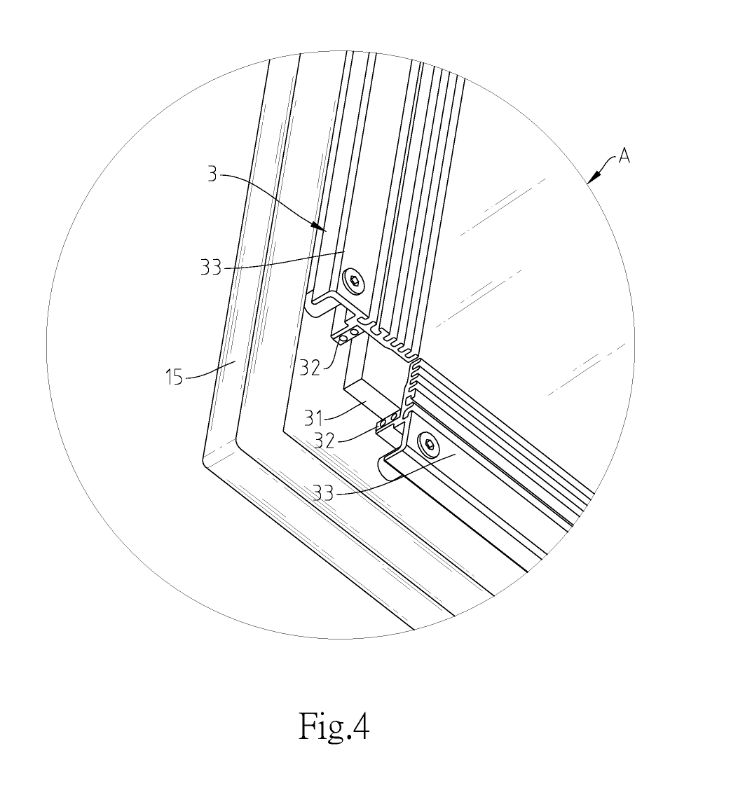

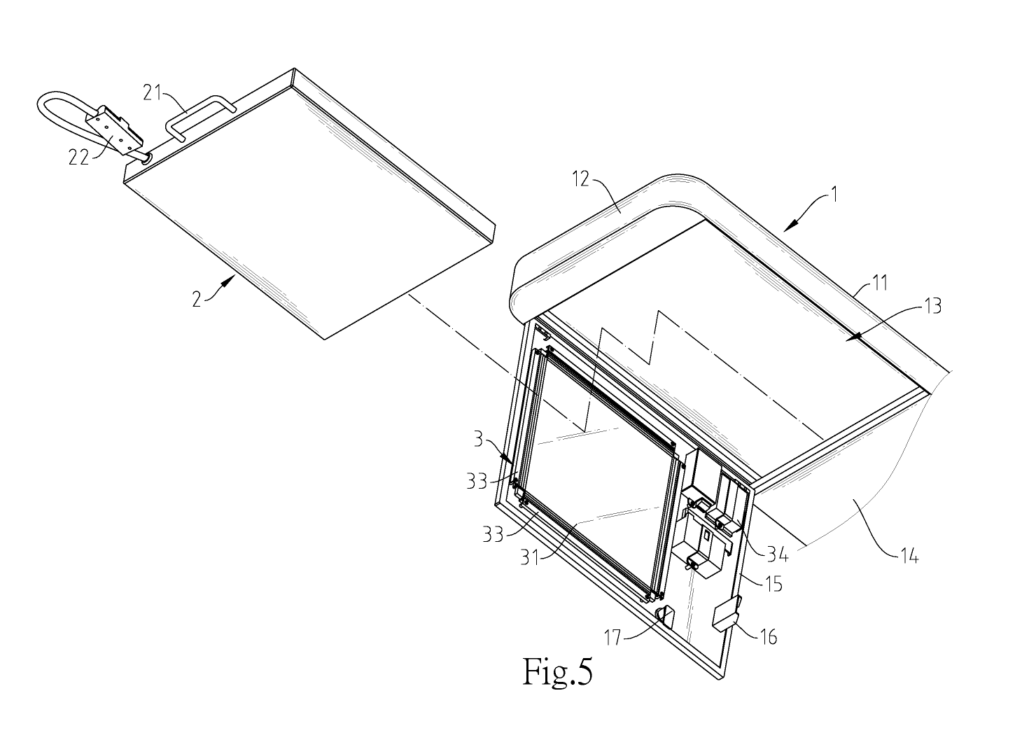

Referring to FIGS. 1-6, a solar street light in accordance with the present invention is shown. The solar street light comprises a lamp housing 1, a battery set 2, and a light source module 3.

The lamp housing 1 is connected to a bracket 5 to hold photovoltaic panels 4, comprising a top panel 11, a plurality of peripheral panels 12 downwardly extended from the border area of the top panel 11, an accommodation chamber 13 surrounded by the top panel 11 and the peripheral panels 12, a fixed bottom panel 14 fixedly connected to the peripheral panels 12 to cover a part of the accommodation chamber 13, a movable bottom panel 15 pivotally connected to one peripheral panel 12 adjacent to the fixed bottom panel 14 and movable between a close position and an open position to close or open the accommodation chamber 13 and defining therein an opening 151, a stop member 16 fixedly mounted at an inner side of the movable bottom panel 15 near the fixed bottom panel 14, and a locking device 17 mounted in the movable bottom panel 15 and adapted to lock the movable bottom panel 15 in the close position.

The battery set 2 is accommodated in the accommodation chamber 13 in between the top panel 11 and the fixed bottom panel 14, comprising a handle 21 and an electrical cable 22 disposed at one side thereof.

The light source module 3 is mounted in the movable bottom panel 15 within the accommodation chamber 13, comprising a light guide plate 31 affixed to the opening 151 of the movable bottom panel 15 by packing members 33, a plurality of light-emitting devices 32 arranged in between the packing members 33 and the light guide plates 31, and a plurality of control components 34 fixedly mounted at the inner surface of the movable bottom panel 15 and electrically coupled with the light-emitting devices 32.

When using the present invention for application, the bracket 5 is fixedly mounted at a street light pole (not shown).

When mounting the battery set 2 to the accommodation chamber 13 in the lamp housing 1, open the movable bottom panel 15, and then put the battery set 2 in the accommodation chamber 13 and then insert the battery set 2 into the space in between the top panel 11 and the fixed bottom panel 14, and then electrically connect the electrical cable 22 of the battery set 2 to the control components 34 of the light source module 3, and the close the movable bottom panel 15, and then fasten up the locking device 17 to lock the movable bottom panel 15 in the close position.

Further, when the movable bottom panel 15 is closed, the stop member 16 is stopped at one side of the battery set 2 to hold down the battery set 12 firmly in the accommodation chamber 13 between the top panel 11 and the fixed bottom panel 14, avoiding battery set displacement.

If a light source module repair or maintenance work is necessary, unlock the locking device 17, and then open the movable bottom panel 15, exposing the light source module 3 to the outside to facilitate maintenance and repair work.

When going to remove the battery set 2 from the lamp housing 1, open the movable bottom panel 15, and then hold the handle 21 of the battery set 2 with the hand, and then pull the battery set 2 out of the accommodation chamber 13.

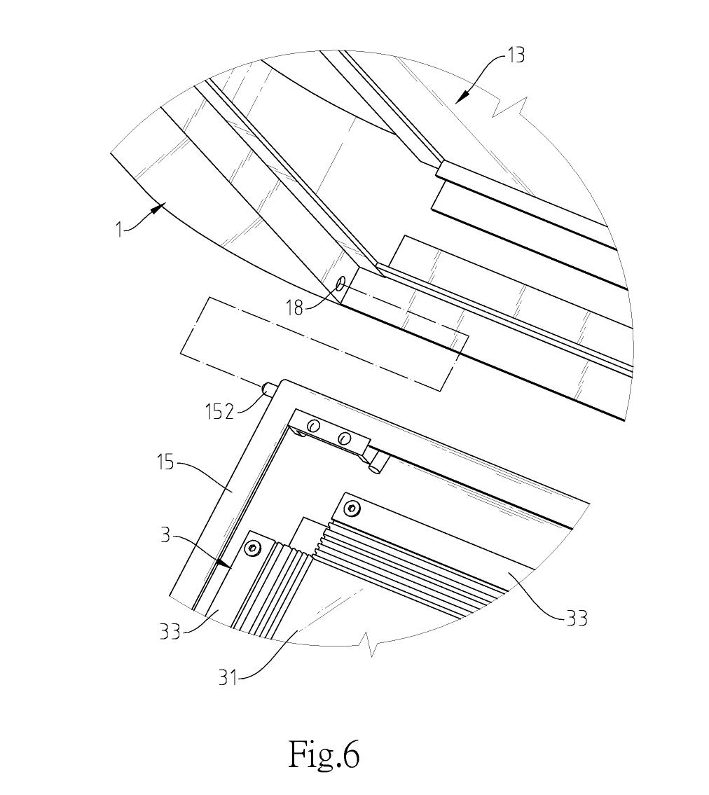

Further, as shown in FIG. 6, the lamp housing 1 further comprises two pivot holders 18 fixedly mounted at an inner side of one peripheral panel 12 and axially aligned in line; the movable bottom panel 15 comprises two pivot pins 152 respectively located at two opposite ends of one side thereof and respectively pivotally coupled to the pivot holders 18. Further, the pivot pins 152 are spring-loaded so that they can be pushed backwardly toward the inside of the movable bottom panel 15, facilitating mounting and dismounting.

As described above, the technical feature of the present invention that eliminates the drawbacks of conventional designs is that the lamp housing 1 uses a fixed bottom panel 14 and a movable bottom panel 15 to enclose the accommodation chamber 13, such that when the movable bottom panel 15 is opened, the battery set 2 can be mounted in or removed from the accommodation chamber 13; when the movable bottom panel 15 is closed after loading of the battery set 2, the stop member 16 stops the battery set 2 firmly in place. Thus, the invention facilitates mounting and dismounting of the battery set 2. Further, the light source module 3 is mounted in the movable bottom panel 15 of the lamp housing 1. When the movable bottom panel 15 is opened, the light source module 3 is exposed to the outside, facilitating maintenance and repair work.

What the invention claimed is:

1. A solar street light, comprising a lamp housing, a bracket fixedly located at one side of said lamp housing for mounting in a street light pole, and photovoltaic panels located at a top side of said lamp housing, wherein:
said lamp housing comprises a top panel, a plurality of peripheral panels downwardly extended from a border area of said top panel, an accommodation chamber surrounded by said top panel and said peripheral panels, a fixed bottom panel fixedly connected to said peripheral panels to cover a part of said accommodation chamber, a movable bottom panel pivotally connected to one said peripheral panel and biasable between a close position to close said accommodation chamber and an open position to open said accommodation chamber, a light source module mounted in said movable bottom panel, and a battery set accommodated in said accommodation chamber in between said top panel and said fixed bottom panel.

2. The solar street light as claimed in claim 1, wherein said movable bottom panel of said lamp housing comprises a stop member disposed at an inner side thereof and adapted for stopping said battery set in said accommodation chamber in between said top panel and said fixed bottom panel when said movable bottom panel is moved to said close position.

3. The solar street light as claimed in claim 1, wherein said movable bottom panel of said lamp housing comprises an opening; said light source module comprises a light guide plate mounted in said opening, and a plurality of light-emitting devices arranged around said light guide plate.

4. The solar street light as claimed in claim 3, wherein said light source module further comprises a plurality of control components fixedly mounted at an inner side of said movable bottom panel and facing toward said accommodation chamber.
